(19) United States
(12) Patent Application Publication
(10) Pub. No.: US 2004/0202075 A1
(43) Pub. Date: Oct. 14, 2004

(54) Information storage apparatus for accessing optical storage medium and method thereof

(75) Inventor: Osamu Ohguri, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/819,114

(22) Filed: Apr. 7, 2004

(30) Foreign Application Priority Data
Apr. 11, 2003 (JP) 2003-108167

(51) Int. Cl. G11B 7/08

(52) U.S. Cl. 369/53.14; 369/112.02; 369/53.13

(57) ABSTRACT

An information storage apparatus includes an optical element, a detector, an adjustment mechanism, a memory and a controller. The optical element emits and/or receives a radiation beam along an optical axis. The detector produces a first signal representing a tilt angle of the storage medium with respect to the detector. The adjustment mechanism compensates a tilt angle between the optical axis of the radiation beam and a direction normal to the optical storage medium in response to a second signal. The memory stores calibration data obtained based on relationship information between the first and second signals and tilt-angle information about the deleted tilt angle. The controller generates the second signal referring to the calibration data such that the tilt angle is substantially canceled. The relationship information reflects a deviation of a property of at least one of the detector and the adjustment mechanism measured by an individual test.

### BACKGROUND OF THE INVENTION

1. Field of the Invention

The present invention relates to an information storage apparatus for accessing an optical storage medium, that is, for performing reproduction and recording in the optical storage medium and a method thereof. Particularly, the present invention relates to an information storage apparatus for compensating a slope angle formed by a normal to a recording surface of an optical storage medium and an optical axis of a radiation beam for accessing the optical storage medium, that is, a tilt angle and a method thereof.

2. Description of the Prior Art

An information storage apparatus records information in an optical disk as an optical storage medium and reads the information recorded in the optical storage medium. In such a case, the information storage apparatus is required to irradiate an optical axis of light emitted from an optical pickup of an optical element perpendicularly to a recording surface of the optical storage medium.

However, there exists a plurality of structural factors, in other words, positional errors and the like in attaching the optical pickup and a spindle motor rotating the optical storage medium. Thus, it is difficult to create an ideal state just by relying on accuracy of mechanical dimensions.

A recent information storage apparatus includes a tilt adjustment mechanism which compensates a tilt for accurately reading information recorded in an optical storage medium and writing information in an optical storage medium. The tilt adjustment mechanism compensates a tilt angle between an optical axis and the optical storage medium so as to be optimum.

In a conventional method by which the tilt is compensated when the optical storage medium is mounted on the information storage apparatus, the tilt is compensated at only one arbitrary point in radial direction of a disk. However, an optical storage medium formed of polycarbonate or the like normally has a warp. Therefore, tilt adjustment is not in its optimum state depending on a position of accessing the optical storage medium. The tile angle is locally optimized by use of the method described above.

Thus, for example, as shown in FIG. 24, an eccentric cam 104 is attached to a guide rail 102 which guides an optical pickup 101. The eccentric cam 104 is provided on an outer circumferential side of an optical disk 103. The eccentric cam 104 is rotated to tilt the guide rail 102 up and down. The tilt of the guide rail 102 allows the optical pickup 101 to track a warp of the optical disk 103.

In this disk device, a tilt sensor is attached to a base of the optical pickup 101. The tilt sensor detects a tilt angle between a normal to a recording surface of the optical disk 103 and an optical axis of a radiation beam from the optical pickup 101. As shown in FIG. 25, a tilt detection signal from the tilt sensor 105 is supplied to a tilt compensation mechanism 106. A tilt control system forms a closed loop.

In the case of accessing the optical disk 103, the tilt sensor 105 measures a tilt at a radial position to be accessed on the optical disk 103. The eccentric cam 104 is rotated according to the detection signal from the tilt sensor 105 so as to have an optimum tilt angle between an optical axis of a radiation beam from the optical pickup 101 and the normal to the recording surface of the optical disk 103. Therefore, optimum tilt control is performed regardless of a position of accessing the optical disk 103.

Moreover, description will be given of an example of a tilt servo control device of a disk device which gets rid of a tilt sensor. In Japanese Patent Laid-Open No. Hei 11 (1999)-003531, a specific liquid crystal panel is disposed on an optical axis of a radiation beam from an optical pickup. The specific liquid crystal panel is driven and the optical axis of light emitted from the optical pickup is tilted so as to have a maximum level of a RF signal outputted from the optical pickup, that is, a signal for determining a tilt optimum position.

In this disk device, a liquid crystal panel for aberration correction is disposed in the optical pickup. In the disk device, this liquid crystal panel is driven and controlled in accordance with types of the optical disk. Thus, optimum tilt servo control is performed for a plurality of different types of optical disks.

Japanese Patent Laid-Open No. Hei 9 (1997)-305996 discloses an optical disk device which includes a tilt adjustment function wherein an actuator is mounted on an optical pickup, in addition to a focusing function for tracking a wobbly surface of an optical disk and a tracking function for tracking an eccentric recording track.

Japanese Patent Laid-Open No. Hei 11 (1999)-144280 and Japanese Patent Laid-Open No. Hei 10 (1998)-172163 disclose an optical disk device which includes an optical pickup mounting a tilt sensor for detecting an angle formed by a normal to a recording surface of an optical disk-and an optical axis of a radiation beam irradiated from the optical pickup. The tilt sensor detects a tilt between the recording surface of the optical disk and the optical axis of the radiation beam irradiated from the optical pickup. The tilt sensor inputs an application voltage corresponding to the detected tilt into a tilt adjustment part of an actuator. The actuator compensates the tilt by controlling the optical pickup in accordance with the inputted application voltage.

However, in any of the foregoing technologies, there exists a deviation of a property found in various parts in an apparatus. The deviation of a property includes, for example, a variation in sensitivity of the tilt sensor and a variation in sensitivity of the actuator which performs tilt adjustment of the optical pickup. Because of these deviations of properties, the tilt angle is not properly compensated.

Moreover, there is also a problem that feedback control performed therein makes a configuration complicated, which leads to cost increases.

In a tilt servo mechanism using no tilt sensor, which is disclosed in Japanese Patent Laid-Open No. Hei 11 (1999)-003531, it is required to additionally provide a drive mechanism and to dispose a special component in the optical pickup. Thus, there is a problem that miniaturization of the optical disk device and cost reduction thereof are inhibited.

In Japanese Patent Laid-Open No. Hei 11 (1999)-144280, the tilt sensor is attached to a movable part of the actuator. Thus, the tilt between the tilt sensor and the normal to the recording surface of the disk is detected. However, there is no consideration given to respective individual deviations and the like of the tilt sensor and the actuator. Therefore, it is not accurately detected how the optical axis of the radiation beam from an actual optical pickup is related to the normal to the recording surface of the disk. Thus, it is difficult to perform high-precision tilt control. Moreover, there is a problem that weight of an object to be driven is increased.

Moreover, Japanese Patent Laid-Open No. 2000-339727 discloses a method for performing tilt control by storing adjustment values of tilt in a map manner and using the adjustment values according to access positions. In this document, when an optical disk is mounted on an information storage apparatus, the tilt is detected at a plurality of positions on the disk. Based on the tilt detected at the plurality of positions, the locus concerning the tilt of the disk is created. In such a manner, in this document, the tilt of the entire disk is obtained by utilizing the created locus. Therefore, in this document, feedback control is not required.

However, in Japanese Patent Laid-Open No. 2000-339727, there is no consideration given to a variation in sensitivity of individual tilt sensors and a variation in sensitivity of individual actuators performing tilt adjustment of an optical pickup. Therefore, although a tilt angle between the tilt sensor and a normal to a recording surface of the disk is detected, a tilt angle between an optical axis of the optical pickup and the normal to the recording surface of the disk cannot be known for certain. Thus, it is difficult to perform high-precision tilt control.

### SUMMARY OF THE INVENTION

It is an object of the present invention to improve control accuracy of a tilt servo mechanism. Moreover, it is another object of the present invention to achieve a stable access to an optical storage medium. It is still another object of the present invention to provide an information storage apparatus having a simple configuration capable of contributing to miniaturization and cost reduction.

More specifically, the object of the present invention is to achieve a tilt adjustment in consideration of deviations of properties of the components such as a detector and an adjustment mechanism. The deviations of properties may be measured by an individual testing.

An information storage apparatus according to the present invention comprises an optical element, a detector, an adjustment mechanism, a memory and a controller. The optical element emits and/or receives a radiation beam along an optical axis. The detector produces a first signal representing a tilt angle of the storage medium with respect to the detector. The adjustment mechanism compensates a tilt angle between the optical axis of the radiation beam and a direction normal to the optical storage medium in response to a second signal. The memory stores calibration data obtained based on relationship information about a relationship between the first and second signals and tilt-angle information about the tilt angle detected by the detector. The controller generates the second signal referring to the calibration data such that the tilt angle is substantially canceled. The relationship information reflects a deviation of a property of at least one of the detector and the adjustment mechanism measured by an individual test.

The deviation of properties may include an actuator sensitivity Kc, a zero shift β0 of a compensation angle, a sensor sensitivity Ka and a zero shift α0 of the detection angle. The deviation of properties may be a position error introduced during assembling the components.

### BRIEF DESCRIPTION OF THE DRAWINGS

This above-mentioned and other objects, features and advantages of this invention will become more apparent by reference to the following detailed description of the invention taken in conjunction with the accompanying drawings, wherein:

FIG. 1 shows a configuration of an information storage apparatus according to a first embodiment of the present invention;

FIG. 2 shows the configuration of the information storage apparatus;

FIG. 3 is a cross-sectional view showing a configuration of a lens actuator of the information storage apparatus;

FIG. 4 is a view for explaining displacement of an objective lens of an optical pickup by the lens actuator;

FIG. 5 is a block diagram showing a configuration of a memory of the information storage apparatus;

FIG. 6 shows data stored in the memory;

FIG. 7 is a graph showing a relationship between a voltage applied to the lens actuator and a compensation angle;

FIG. 8 is a view for explaining a shift amount of the compensation angle at a zero point of the voltage;

FIG. 9 is a graph showing a relationship between a detection angle detected by a tilt sensor of the optical pickup and an output voltage of the tilt sensor;

FIG. 10 is a view for explaining a shift amount of the detection angle at a zero point of the voltage;

FIG. 11 is a flowchart for explaining operations of an evaluation/adjustment device used in an adjustment step when the information storage apparatus is manufactured;

FIG. 12 is a flowchart for explaining operations of an evaluation/adjustment device used in an adjustment step when the information storage apparatus-is manufactured;

FIG. 13 is a flowchart for explaining operations of the information storage apparatus;

FIG. 14 shows contents of calibration data stored in the memory;

FIG. 15 shows a configuration of an information storage apparatus according to a second embodiment of the present invention;

FIG. 16 shows data stored in the memory in a second embodiment;

FIG. 17 is a flowchart for explaining operations of the information storage apparatus;

FIG. 18 shows data stored in the memory in a second embodiment;

FIG. 19 shows a configuration of an information storage apparatus according to a third embodiment of the present invention;

FIG. 20 shows data stored in the memory in a third embodiment;

FIG. 21 shows data stored in the memory in a third embodiment;

FIG. 22 is a flowchart for explaining operations of the information storage apparatus;

FIG. 23 shows data stored in the memory in a third embodiment;

FIG. 24 is a view for explaining a conventional technology; and

FIG. 25 is a view for explaining a conventional technology.

### DETAILED DESCRIPTION OF THE PREFERRED EMBODIMENTS

With reference to the drawings, embodiments of the present invention will be described below.

### First Embodiment

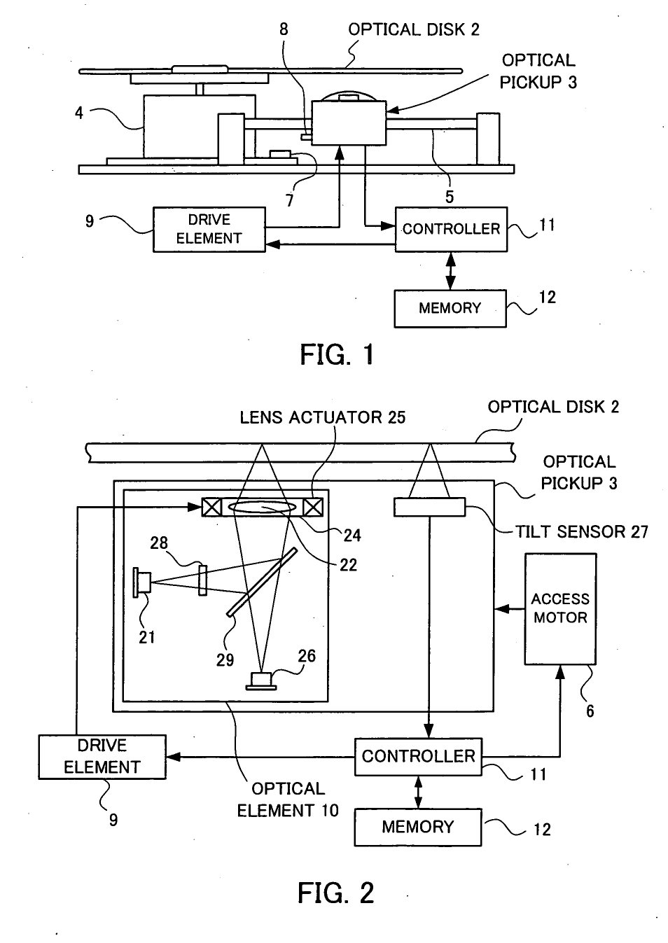

FIGS. 1 and 2 show a configuration of an information storage apparatus according to a first embodiment of the present invention.

As shown in FIG. 1, the information storage apparatus 1 is used for accessing an optical storage medium 2 such as a CD (compact disk), a CD-ROM, a DVD and a magneto-optical disk, in other words, an optical disk.

As shown in FIGS. 1 and 2, the information storage apparatus 1 includes an optical pickup 3, a so-called optical head. The optical pickup 3 irradiates a radiation beam emitted from a semiconductor laser element as a light source onto the optical disk 2, receives light reflected from the optical disk 2 and generates a signal corresponding to intensity of the received light.

Moreover, the information storage apparatus 1 includes a spindle motor 4, which rotates the optical disk 2, and a guide rail 5. The guide rail 5 is provided substantially parallel to the optical disk 2. The guide rail 5 supports the optical pickup 3 and guides the optical pickup 3 to move in a radial direction of the optical disk 2. The information storage apparatus 1 further includes an access motor 6 for moving the optical pickup 3 along the guide rail 5 in the radial direction of the optical disk 2. The information storage apparatus 1 includes: a first sensor 7 for detecting an innermost circumferential position of the optical disk 2; and a second sensor 8 for detecting a position of the optical pickup 3, that is, an amount of movement from the innermost circumferential position. The information storage apparatus 1 includes an adjustment mechanism for compensating a tilt angle. The adjustment mechanism includes a lens actuator 25 to be described later and a drive element 9 which drives the lens actuator 25. The information storage apparatus 1 includes a controller 11 which controls the optical pickup 3, the access motor 6 and the like. Furthermore, the information storage apparatus 1 includes a memory 12 for storing processing programs to be executed by the controller 11, various data and the like.

As shown in FIG. 2, the optical pickup 3 includes an optical element 10 and a tilt sensor 27. The optical pickup 3 includes: a semiconductor laser element 21; an objective lens (a part of an optical system) 22 which concentrates radiation beams; a lens holder (a movable part) 24 which holds the objective lens 22; and a photo-detector 26. Moreover, a lens actuator 25 is attached to the lens holder 24. The lens actuator 25 drives the lens holder 24 and the objective lens 22 in order to track a grove or a track in an optical disk 2 despite surface wobbling, eccentricity and warp of the optical disk 2. As shown in FIG. 2, the radiation beam emitted from the semiconductor laser element 21 is guided to the objective lens 22 through a diffraction grating 28 and a half mirror 29. The radiation beam is irradiated on the optical disk 2 through the objective lens 22. Moreover, light reflected from the optical disk 2 is guided to the photo-detector 26 through the half mirror 29.

The detector 27 is a tilt sensor. The tilt sensor 27 detects a tilt angle between a normal to a recording surface of the optical disk and an optical axis of the radiation beam irradiated from the optical element 10. The tilt sensor 27 outputs a first signal corresponding to the detected tilt angle.

The tilt sensor 27 is fixed on an optical base to which an actuator base 31 of the lens actuator 25 is attached. The tilt sensor 27 is not displaced simultaneously with the objective lens 22.

The lens actuator 25 has a tilt adjustment function for adjusting the optical axis of the radiation beam from the optical element 10 with respect to a tilt of the optical disk 2. The lens actuator 25 further has a focusing function for tracking the wobbly surface of the optical disk 2 and a tracking function for tracking a recording track despite eccentricity of the optical disk 2, the spindle motor 5 and the like.

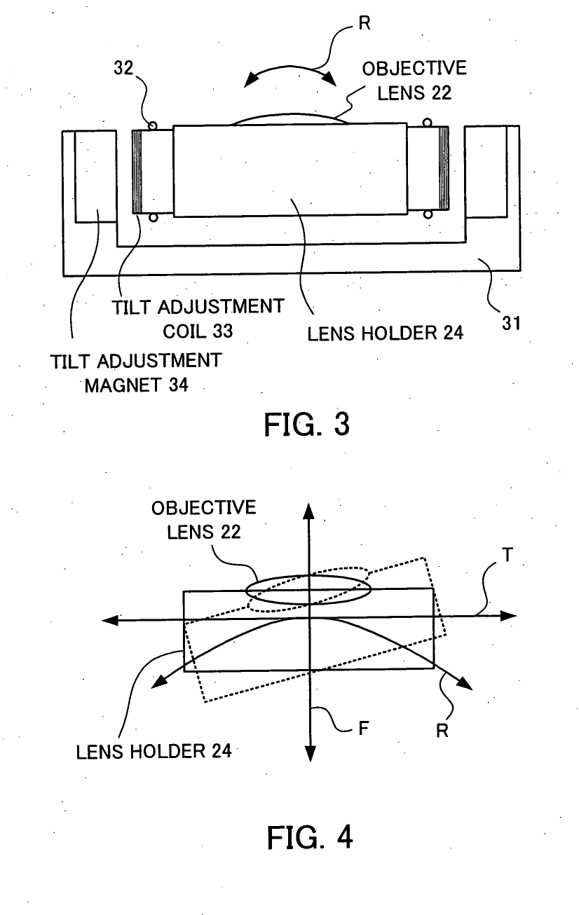

With reference to FIG. 3, the lens actuator 25 includes a wire-shaped elastic supporting member 32 for attaching the lens holder 24 to the actuator base 31. Moreover, the lens actuator 25 includes a tilt adjustment coil 33 which is provided with the lens holder 24, a focusing coil (not shown) and a tracking coil (not shown). The lens actuator 25 includes a tilt adjustment magnet 34 which is provided in the actuator base 31 so as to face the tilt adjustment coil 33, a focusing magnet (not shown) and a tracking magnet (not shown).

As shown in FIG. 4, the lens holder 24 holding the objective lens 23 can be moved along a tracking direction T, a focusing direction F and a tilt direction R by means of the elastic supporting member 32.

For example, when a predetermined voltage V is applied to the tilt adjustment coil 33 via the drive element 9, a magnetic flux generated in the tilt adjustment coil 33 and a magnetic flux of the tilt adjustment magnet 34 interact with each other. Thus, the lens holder 24 is moved along the tilt direction R against tension of the elastic supporting member 32. The tilt angle is compensated by the movement of the lens holder 24. The same goes for adjustment in the focusing direction F and adjustment in the tracking direction T. As the voltage V increases, the degree of the displacement of the lens holder 24 along the tilt direction R increases.

The controller 11 includes a processing unit and the like. The controller 11 executes various processing programs stored in the memory 12 and controls components of the information storage apparatus 1.

The controller 11 executes, for example, actuator drive voltage calculation processing, actuator control processing and the like based on the various processing programs stored in the memory 12.

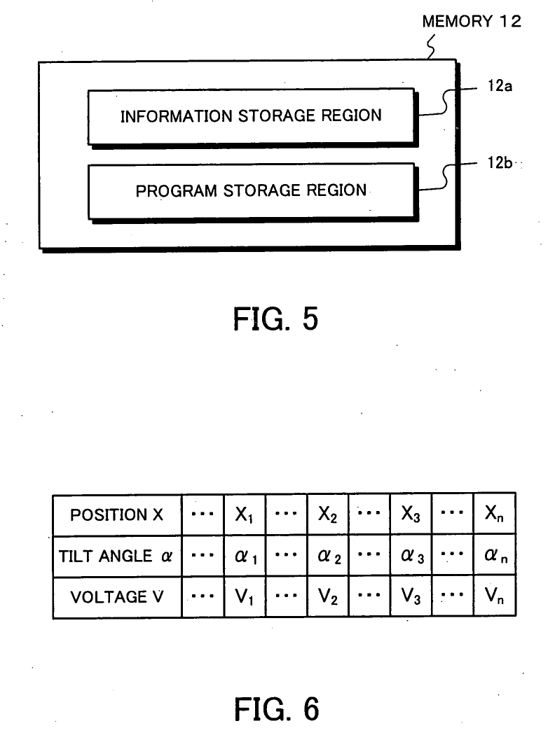

The memory 12 is formed of a semiconductor memory such as a ROM and a RAM. As shown in FIG. 5, the memory 12 includes: an information storage part 12a which stores various information; and a program storage part 12b which stores various processing programs, such as an actuator drive voltage calculation program and an actuator control program, which are executed by the controller 11.

The information storage part 12a stores calibration data. The calibration data is obtained based on relationship information and tilt-angle information. The relationship information is information about a relationship between the first signal from the tilt sensor 27 and a second signal used for optical axis adjustment by the adjustment mechanism. The tilt-angle information is information about the tilt angle detected by the tilt sensor 27. The calibration data is data for obtaining the second signal.

The relationship information reflects a deviation of a property of the adjustment mechanism or the tilt sensor 27, which is measured by an individual test in an assembly/adjustment step at the time of manufacturing the optical pickup 3. Specifically, the relationship information includes adjustment data such as actuator sensitivity Kc, zero shift β0 of a compensation angle, sensor sensitivity Ka and zero shift α0 of a detection angle. By use of the adjustment data described above, a deviation of a property included in each optical element 10 is compensated.

The controller 11 generates the second signal to the adjustment mechanism by referring to the calibration data obtained based on the relationship information and the tilt-angle information such that the tilt angle is substantially canceled. The second signal is specifically the voltage V applied to the lens actuator 25. Thus, a tilt angle a corresponding to a position in the radial direction of the optical disk 2 and the voltage V applied to the lens actuator 25 are calculated with high accuracy.

The adjustment data is based on results of measurement of individual test in the assembly/adjustment step at the time of manufacturing the information storage apparatus 1. The adjustment data is obtained as below.

Specifically, first, a relationship between the voltage to the lens actuator 25, that is, an actuator drive voltage V and a compensation angle β in the optical pickup 3 is examined. Thus, the actuator sensitivity Kc and the zero shift β0 of the compensation angle are obtained.

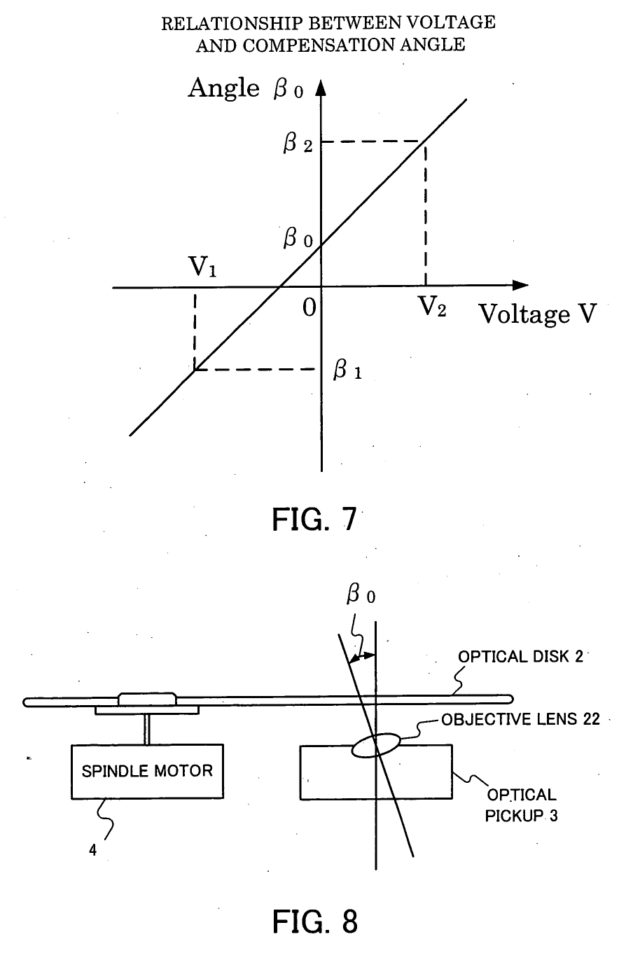

Here, the compensation angle β is a slope angle of the optical axis when the application voltage V is applied to the lens actuator 25. As shown in FIG. 7, the application voltage V and the compensation angle β has an approximately linear relationship. The actuator sensitivity Kc is given as a slope of a straight line shown in FIG. 7. The actuator sensitivity Kc is obtained by the equation (1) as the slope angle of the optical axis based on compensation angles β1 and β2 when arbitrary voltages V1 and V2 are inputted.

Kc=(β2−β1)/(V2−V1) (1)

The optical axis of light irradiated from the optical pickup 3 is ideally perpendicular to the optical disk 2 when the application voltage V applied to the lens actuator 25 is zero. However, in reality, as shown in FIG. 8, a zero point is shifted and the zero shift β0 remains when the application voltage V is zero. This zero shift β0 is stored in the memory 12 as the adjustment data together with the actuator sensitivity Kc.

Moreover, similarly to the lens actuator 25, a relationship between a detection angle α and an output voltage Vc in the tilt sensor 27 is obtained. Thus, the sensor sensitivity Ka and the zero shift α0 of the detection angle are obtained.

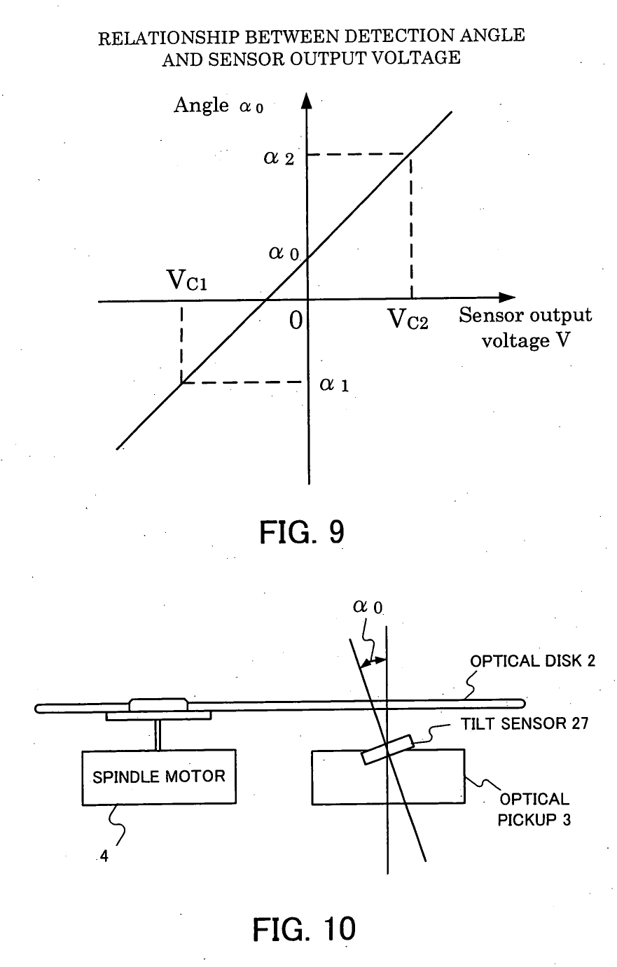

Here, the detection angle α is a slope angle of the optical disk 2 with respect to the optical pickup 3. The output voltage Vc is a voltage corresponding to the detection angle α. The tilt sensor 27 outputs the output voltage Vc corresponding to the detected detection angle α as the first signal. As shown in FIG. 9, the output voltage Vc and the detection angle α has an substantially linear relationship. The sensor sensitivity Ka of the tilt sensor 27 is given as a reciprocal number of a slope of a straight line shown in FIG. 9. The sensor sensitivity Ka is obtained by the equation (2) based on output voltages Vc1 and Vc2 of the tilt sensor 7 when arbitrary detection angles α1 and α2 are set.

Ka=(Vc2−Vc1)/(α2−α1) (2)

The tilt sensor 27 basically detects an angle formed by the normal to the recording surface of the optical disk 2 and the optical axis of the light irradiated from the optical element 10. Therefore, it is ideal that the tilt sensor 27 outputs zero when the above-described normal and optical axis coincide with each other. However, in reality, there exists an error in accuracy of components of the tilt sensor 27, that is, a deviation of a property such as a drive error and an assembly error. Therefore, as shown in FIG. 10, a zero point is shifted and the zero shift α0 remains. This zero shift α0 is also stored in the memory 12 as the adjustment data together with the sensor sensitivity Ka.

The tilt sensor 27 detects the detection angle a corresponding to the position in the radial direction of the optical disk 2 when the optical disk 2 is mounted on the information storage apparatus 1. The detection angle α is obtained as a function of the position X in the radial direction as shown in the equation (3) and is stored in the memory 12 as shown in FIG. 6.

This detection angle α is an angle to be compensated as the tilt angle. The controller 11 drives the lens actuator 25 by means of the drive element 9 such that “α=β” is established, that is, the tilt angle is canceled. Thus, the tilt angle is compensated and the deviation of the property existing in the tilt sensor 27 and the lens actuator 25 is also compensated.

α(X)=F(X) (3)

The program storage part 12b stores the actuator drive voltage calculation program, the actuator control program and the like.

In the actuator drive voltage calculation program, described is a procedure for calculating the voltage V to be applied to the actuator 25 at each position of the optical pickup 3, i.e., the second signal, based on the calibration data stored in the memory 12.

In reality, the detection angle α of the tilt sensor 27 and the compensation angle β of the actuator 25 are obtained by the equations (4) and (5), respectively.

α=(1/Ka)×Vc+α0 (4)

β=Kc×V+β0 (5)

Here, as described above, Vc is the output voltage of the tilt sensor 27 and V is the voltage applied to the actuator 25.

Therefore, by use of the calibration data obtained based on the tilt-angle information and the relationship information, the voltage V is generated such that a tilt error is substantially canceled as shown in the equation (6).

V=((1/Ka)×Vc+α0−β0)/Kc (6)

Accordingly, the voltage V applied to the actuator 25, which corresponds to the output voltage Vc outputted from the tilt sensor 27, is calculated. Thus, an accurate compensation angle β according to the detection angle α is obtained.

When the optical disk 2 is set in the apparatus, the detection angles α according to a plurality of predetermined positions in the radial direction of the optical disk 2 are detected, respectively, by the tilt sensor 27. The detection angle α is approximated as the function of the position X in the radial direction as shown in the equation (3).

The detection angle α is an angle to be adjusted. The controller 11 drives the lens actuator 25 by means of the drive element 9 such that “α=β” is established.

Specifically, the voltage V to be applied to the actuator 25 at the position X is calculated based on the detection angle α at the position X detected by the tilt sensor 27 and the previously stored adjustment data, that is, the actuator sensitivity Kc of the actuator 25, the zero shift β0 and the like.

Here, in the case of performing feed-forward control, the voltage V applied to the actuator 25 is obtained as the function of the position X in the radial direction as shown in the equation (7). As shown in FIG. 6, data calculated by the equation (7) is stored in the memory 12 together with the position X and the detection angle α(X) (=F(X)).

V(X)=(F(X)−β0)/Kc (7)

In the actuator control program, described is a procedure for compensating the tilt angle formed by the normal to the recording surface of the optical disk 2 and the optical axis of the radiation beam irradiated from the optical pickup 3.

In the case of not performing the feed-forward control, the controller 11 may calculate the voltage V in each access position by use of the tilt-angle information from the tilt sensor 27 corresponding to the access position.

Meanwhile, in the case of performing the feed-forward control, the output voltage V corresponding to the position X is read as the second signal from the data which is calculated by the equation (7) based on positional information of the optical pickup 3 and is stored in the memory 12. Accordingly, the lens actuator 25 is driven.

In either case, the controller 11 drives the actuator 25 so as to align the optical axis of the light irradiated from the optical element 10 with the normal to the recording surface of the optical disk 2.

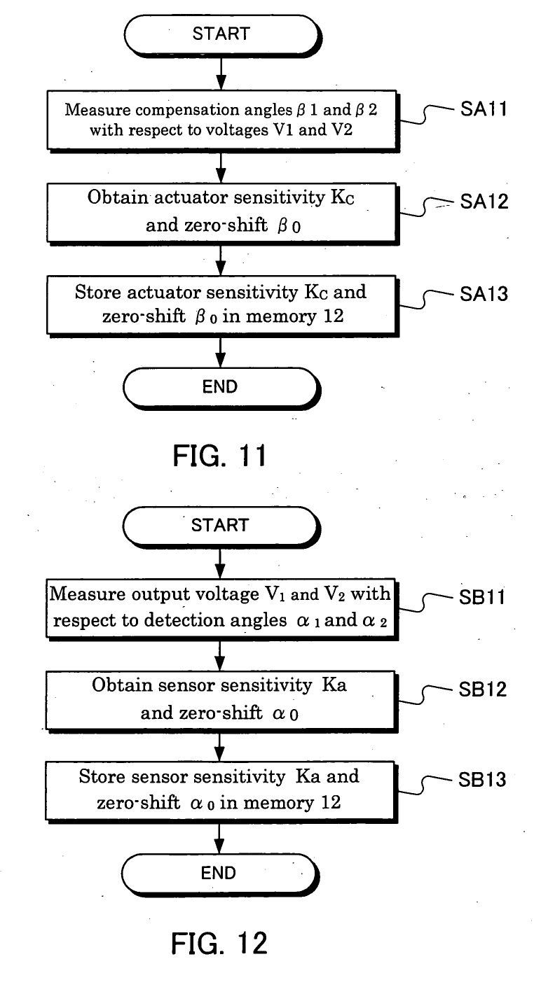

Next, with reference to FIGS. 11 to 14, description will be given of operations of the information storage apparatus 1 in the case of performing the feed-forward control.

As described above, in the information storage apparatus 1, first, the compensation angles β1 and β2 with respect to the voltages V1 and V2 regarding the optical element 10 are measured by individual test in the assembly/adjustment step at the time of manufacturing thereof (Step SA11 (FIG. 11)). From those results of measurement, the actuator sensitivity Kc and the zero shift β0 of the compensation angle are calculated (Step SA12). The actuator sensitivity Kc and the zero shift β0 of the compensation angle are stored in the memory 12 as the adjustment data (Step SA13).

Next, the output voltages Vc1 and Vc2 with respect to the detection angles α1 and α2 regarding the tilt sensor 27 are measured (Step SB11 (FIG. 12)). From those results of measurement, the sensor sensitivity Ka and the zero shift α0 of the detection angle are obtained (Step SB12). The sensor sensitivity Ka and the zero shift α0 of the detection angle are stored in the memory 12 as the adjustment data (Step SB13).

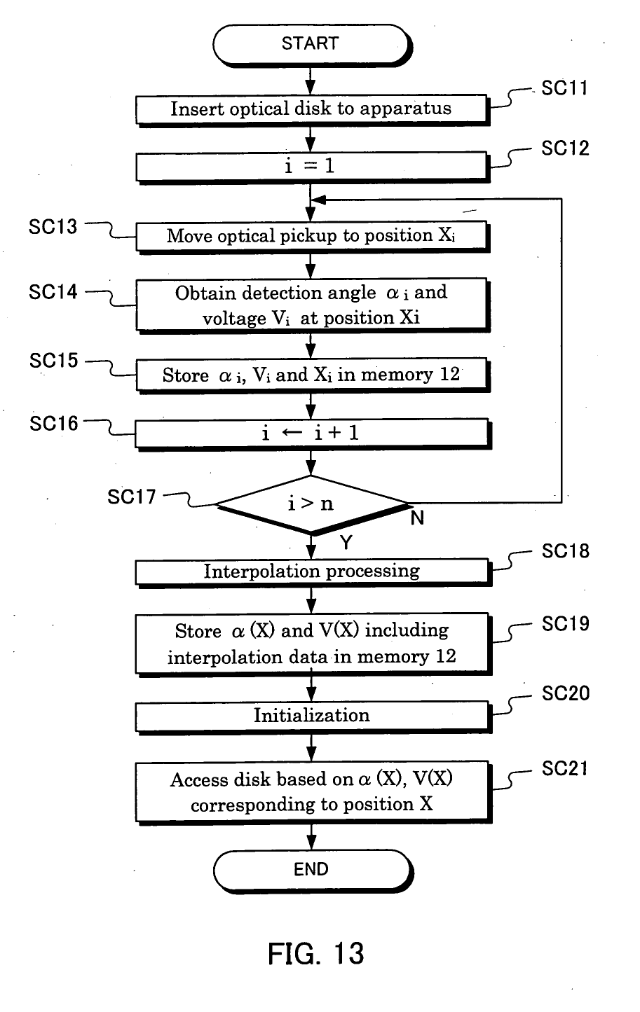

Next, with reference to FIG. 13, the optical disk 2 is inserted into the information storage apparatus 1 and operation thereof is started (Step SC11). The controller 11 detects the innermost circumferential position of the optical disk 2 by use of a detection signal from the first sensor 7 before performing a normal initialization operation.

The controller 11 detects the position X as a distance of movement from the innermost circumferential position by use of a detection signal from the second sensor 8. The controller 11 controls the access motor 6 to displace the optical pickup 3 to a predetermined position Xi (i=1, 2, . . . n) which is previously set.

Specifically, the controller 11 first sets i=1 (Step SC12) and moves the optical pickup 3 to the position X1 (Step SC13).

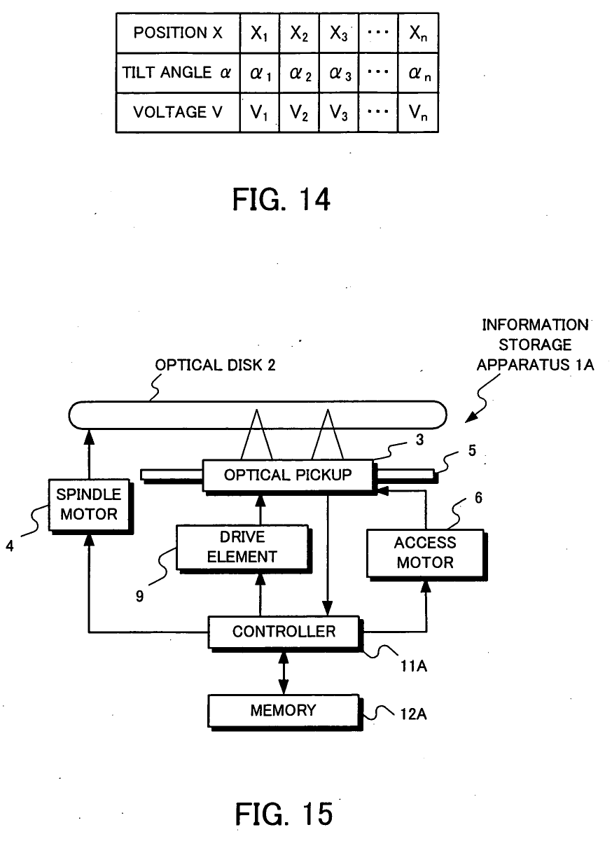

The controller 11 generates voltage V 1 at the position X1 based on the output voltage Vc1 corresponding to the detection angle α1 from the tilt sensor 27 (Step SC14). As shown in FIG. 14, the controller 11 stores the position X, the detection angle α and the calculated V (X) in the memory 12 (Step SC15). Here, the detection angle α is not an essential item and should not necessarily be stored in the memory 12.

Next, the controller 11 adds 1 to the value of i (in this case, i=2) (Step SC16). In Step SC17, it is determined whether or not the value i exceeds value n. When the value i does not exceed value n, the controller 11 repeats the processing of Steps SC13 to SC17.

When it is determined that the value i exceeds value n in Step SC17, the controller 11 performs interpolation processing in Step SC18. Specifically, the controller 11 interpolates the detection angle α and the voltage V with respect to an arbitrary position X on the optical disk 2 based on αi (Xi) (=F (Xi)) and V (Xi) which are discretely obtained. The controller 11 calculates the voltage V at the arbitrary position X of the optical pickup and stores the calculated voltage in the memory 12 (Step SC19).

Next, the controller 11 performs initialization processing (Step SC20).

Thereafter, when the information storage apparatus 1 reads information of a predetermined address, the controller 11 controls the access motor 6, to displace the optical element 10 to a desired position X corresponding to the address. The controller 11 reads the voltage V corresponding to the position X from the memory 12. The controller 11 controls the drive element 9 so as to give the read voltage V to the lens actuator 25. The lens actuator 25 changes the optical axis of the radiation beam from the optical element 10 in accordance with the voltage V. Thus, the tilt angle is compensated. The information storage apparatus 1 accesses the position X of the optical disk 2 by the compensated tilt angle (Step SC21).

In such a manner, in accordance with an arbitrary position on the optical disk 2 to be accessed, the application voltage V is applied to the actuator 25 such that the tilt angle is properly canceled. Accordingly, high-precision angle compensation is carried out to gain a good access to the optical disk 2.

As described above, according to the configuration of this embodiment, the controller 11 generates the voltage V corresponding to the position X based on the actuator sensitivity Kc, the zero shift β0 of the compensation angle, the sensor sensitivity Ka and the zero shift α0 of the detection angle which are previously measured by an individual test. In the case of accessing information of a predetermined address, the drive element 9 controls the lens actuator 25 based on the generated voltage V. Accordingly, high-precision tilt control in consideration of each deviation of a property is performed to gain a stable access to the optical disk 2.

Moreover, if the relationship between the position X and the voltage V is previously stored in the memory 12, it is not required to perform the feedback control. Therefore, in this case, the configuration is simplified and miniaturization of the apparatus and cost reduction thereof are realized.

### Second Embodiment

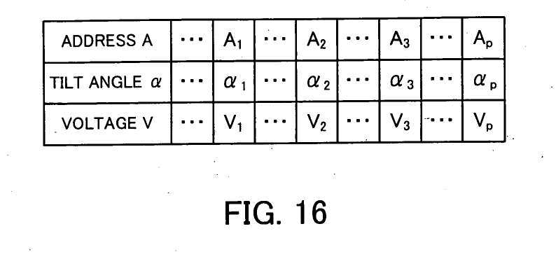

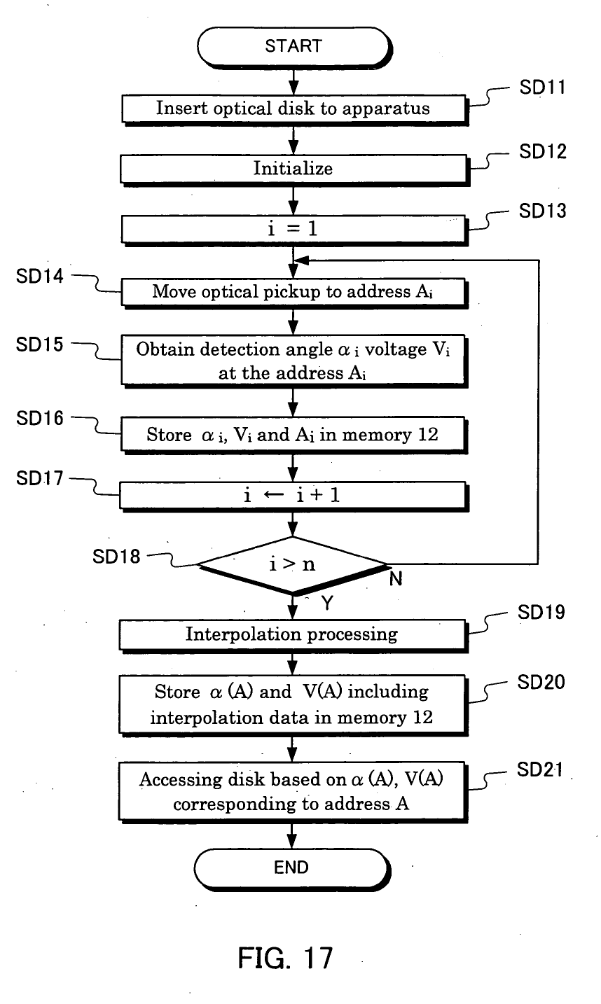

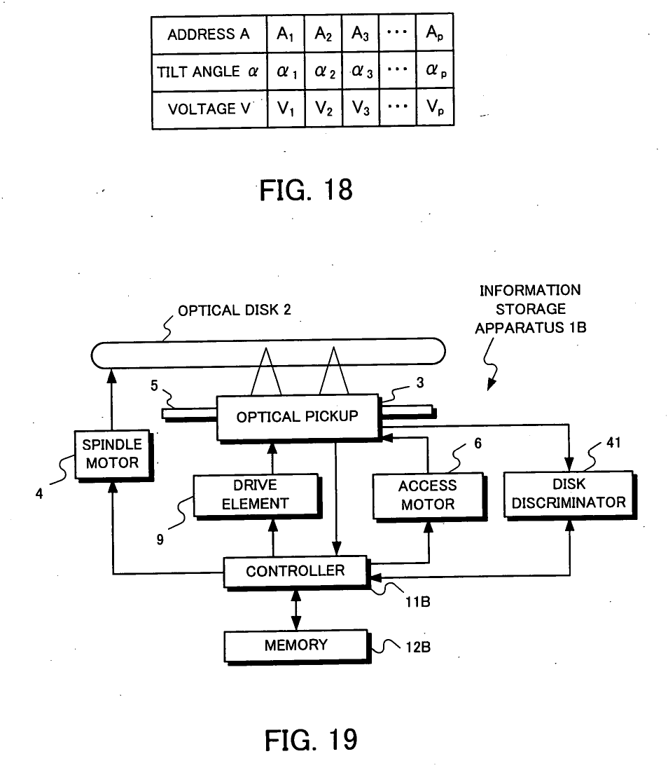

FIG. 15 is a block diagram showing a configuration of an information storage apparatus according to a second embodiment. FIG. 16 shows contents of data stored in a memory 12 of the information storage apparatus. FIG. 17 is a flowchart showing operations of the information storage apparatus. FIG. 18 shows contents of data stored in the memory 12 in the case of performing the feed-forward control.

The second embodiment is significantly different from the first embodiment in that the first sensor 7 for detecting the innermost circumferential position and the second sensor 8 for detecting the position of the optical pickup 3 are omitted. In the second embodiment, the voltage V is obtained as a function of an address of a spiral or concentric track of the optical disk 2, rather than a function of a distance X. Moreover, the second embodiment is different from the first embodiment also in that the tilt control is started after address information of the optical disk 2 is obtained by the initialization processing.

The second embodiment has approximately the same configuration as that of the first embodiment described above except for the points described above. Thus, description thereof will be simplified.

With reference to FIG. 15, the information storage apparatus 1A includes an optical pickup 3, a spindle motor 4, a guide rail 5, an access motor 6, a drive element 9, a controller 11A and a memory 12A. The optical pickup 3 irradiates a radiation beam emitted from a semiconductor laser element onto an optical disk 2. The optical pickup 3 receives light reflected from the optical disk 2 and generates a signal corresponding to intensity of the received light. The spindle motor 4 rotates the optical disk 2. The guide rail 5 is provided substantially parallel to the optical disk 2. The guide rail 5 supports the optical pickup 3 and guides movement of the optical pickup 3 in a radial direction of the optical disk 2. The access motor 6 moves the optical pickup 3 along the guide rail 5 in the radial direction of the optical disk 2. The drive element 9 drives an actuator for performing tilt adjustment of the optical pickup 3. The controller 11A controls the drive element 9, the optical pickup 3, the access motor 6 and the like. The memory 12A stores processing programs to be executed by the controller 11A, various data and the like.

The memory 12A includes: an information storage part 12a which stores various information; and a program storage part 12b which stores programs, such as an actuator drive voltage calculation program and an actuator control program, which are executed by the controller 11A.

The information storage part 12a stores calibration data. The calibration data is obtained based on relationship information and tilt-angle information. The relationship information and the tilt-angle information are similar to those of the first embodiment. Specifically, the relationship information is information about a relationship between a first signal and a second signal used for optical axis adjustment by an adjustment mechanism. The tilt-angle information is information about a tilt angle detected by a tilt sensor 27.

The relationship information reflects adjustment data which is measured by an individual test in an assembly/adjustment step at the time of manufacturing the optical pickup 3. The adjustment data includes, for example, actuator sensitivity Kc, zero shift β0 of a compensation angle, sensor sensitivity Ka and zero shift α0 of a detection angle.

A detection angle α in an arbitrary address A of the optical disk 2 is a function of address information and obtained by the equation (8).

αh(A)=F(A) (8)

Moreover, an voltage V (A) to a lens actuator 25 for tracking an angle to the arbitrary address is obtained by the equation (9).

V(A)=(F(A)−β0)/Kc (9)

In the case of not performing the feed-forward control, the second embodiment is different from the first embodiment only in that control is performed by use of the address A instead of the position X in the first embodiment. Other operations are the same as those of the first embodiment. However, as described above, the second embodiment is different from the first embodiment in that the tilt control is performed after the initialization is performed.

Meanwhile, in the case of performing the feed-forward control, as shown in FIG. 16, the detection angle α and the application voltage V corresponding to the address A of the optical disk 2 instead of the positional information X are stored in the memory 12A.

With reference to FIGS. 17 and 18, description will be given of operations of the information storage apparatus 1A in the case of performing the feed-forward control.

With reference to FIG. 17, first, the optical disk 2 to be reproduced is mounted on the information storage apparatus 1A (Step SD11). The controller 11A performs the initialization processing (Step SD12). Next, the controller 11A performs a preparatory operation for angle compensation. When the initialization of the optical disk 2 is finished, the controller 11A obtains address information of the target optical disk 2. In order to obtain an output of the tilt sensor 27 corresponding to the address information, the controller 11A displaces the optical pickup 3 with respect to a plurality of pre-set addresses Ai (i=1, 2, . . . p).

Specifically, the controller 11A first sets i=1 (Step SD13) and moves the optical pickup 3 to a position corresponding to the address A1 (Step SD14).

The tilt sensor 27 detects the detection angle α1. Based on an output voltage Vc according to the detection angle α1 from the tilt sensor 27, the controller 11A calculates α1 (A1) (=F (A1)) and V1 in the address A1 (Step SD15). As shown in FIG. 18, the controller 11A stores the calculated values in information storage region 12a of the memory 12A (Step SD16).

Next, the controller 11A adds 1 to the value of i (in this case, i=2) (Step SD17). In Step SD18, the controller 11A determines whether or not the value i exceeds value n. When it is determined that the value i does not exceed value n, the controller 11A repeats the processing of Steps SD14 to SD18.

When it is determined that the value i exceeds value n in Step SD18, the controller 11A performs interpolation processing in Step SD19. Specifically, the controller 11A interpolates the detection angle α and the voltage V with respect to an arbitrary address A on the optical disk 2 based on αi (Ai) (=F (Ai)) and V (Ai) which are discretely obtained. The controller 11A calculates a value of the voltage V in the arbitrary address Ai of the optical pickup 3 and stores the value in the memory 12A (Step SD20).

In Step SD21, in the case of reading information of a predetermined address on the optical disk 2, the controller 11A first controls the access motor 6 to displace the optical pickup 3 to the position corresponding to the predetermined address Ax. The controller 11A reads the voltage V corresponding to the address Ax from the memory 12A. The controller 11A controls the drive element 9 so as to give the read voltage V to the lens actuator 25. The lens actuator 25 changes the optical axis of the radiation beam according to the voltage V. Thus, the tilt angle is compensated. The information storage apparatus 1A accesses the address Ax on the optical disk 2 by the compensated tilt angle (Step SD21).

As described above, the information storage apparatus 1A determines the voltage V to the lens actuator 25 having an adjustment function by use of a disk address on the optical disk 2 to be accessed. Therefore, high-precision angle compensation including compensation of a deviation of a property is executed to gain a good access to the optical disk 2.

According to the configuration of this embodiment, it is possible to obtain an effect approximately similar to that of the first embodiment described above.

In addition, since the first and second sensors can be omitted, costs can be reduced.

### Third Embodiment

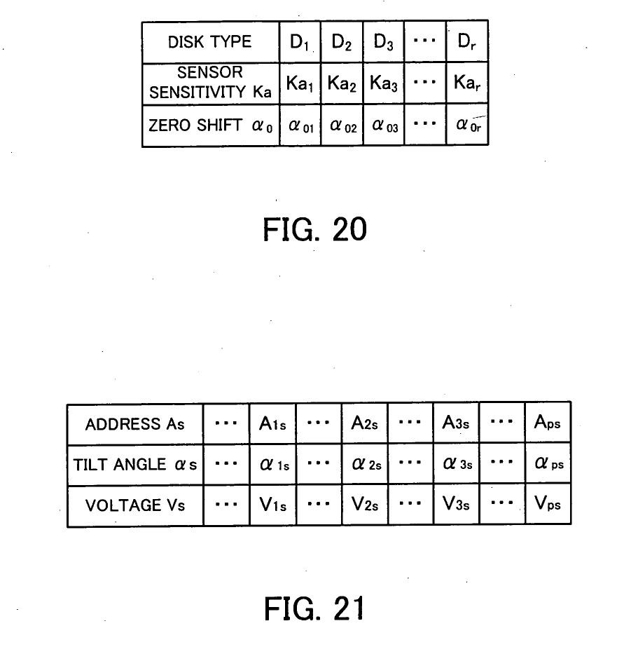

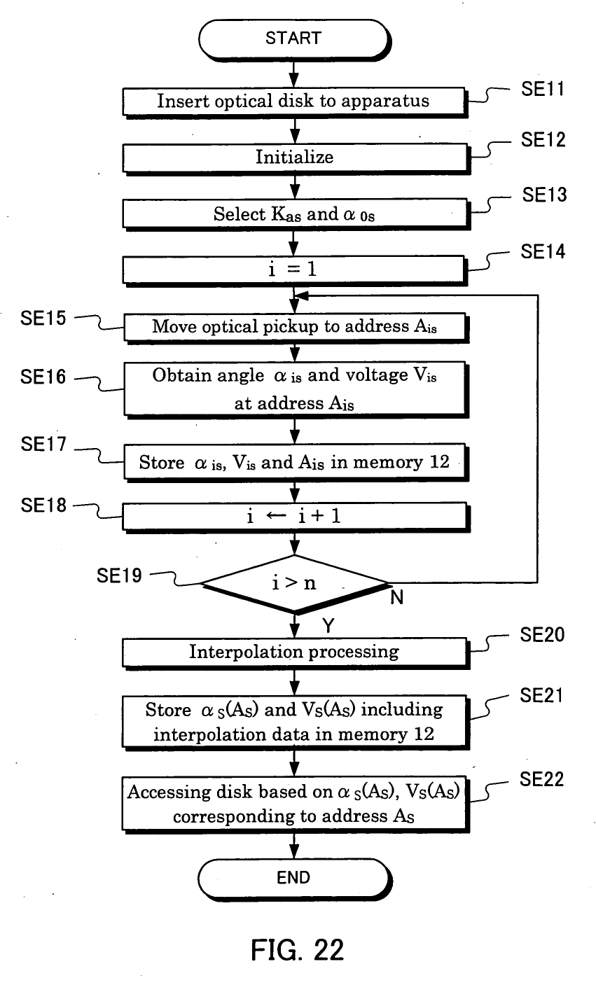

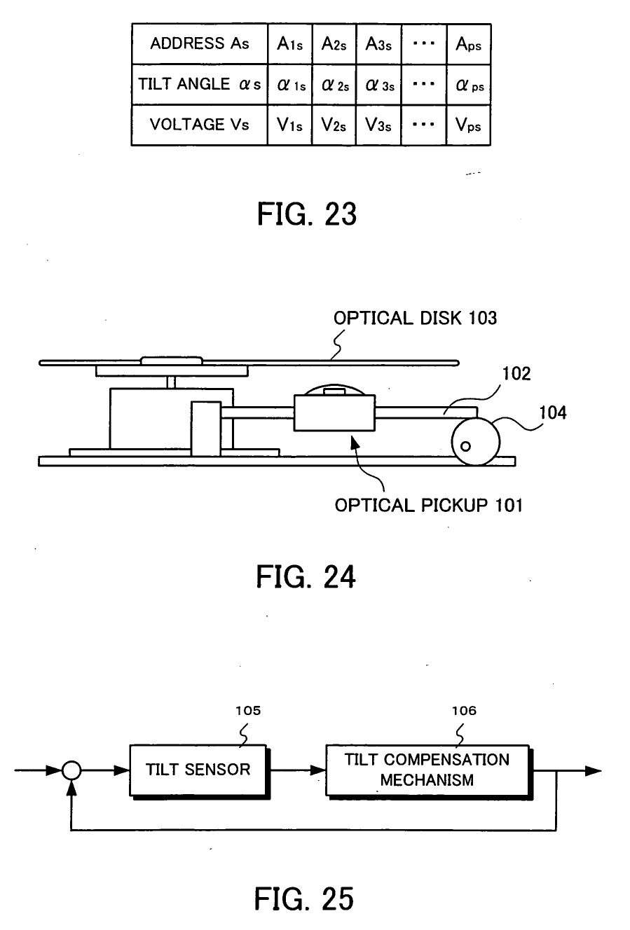

FIG. 19 is a block diagram showing a configuration of an information storage apparatus-according to a third embodiment of the present invention. FIGS. 20 and 21 show contents of data stored in information storage region 12a of a memory 12B of the information storage apparatus. FIG. 22 is a flowchart showing operations of the information storage apparatus. Moreover, FIG. 23 shows contents of data stored in the memory 12B in the case of performing the feed-forward control.

This embodiment is different from the second embodiment in that the information storage apparatus 1B includes a disk discriminator 41 which detects a plurality of types of optical disks. In the memory 12B, actuator sensitivity Kc, zero shift β0 of a compensation angle, sensor sensitivity Ka and zero shift α0 of a detection angle, which are used for each type of the optical disk, are stored. This is because the above-described data stored in the memory 12B is used in order to perform compensation suitable for each optical disk in consideration of a property according to the type of the optical disk, in other words, in order to carry out a tilt adjustment despite differences in recording surfaces of the plurality of types of the optical disk.

The third embodiment has approximately the same configuration as that of the second embodiment described above except for the points described above. Thus, description thereof will be simplified.

As shown in FIG. 19, the information storage apparatus 1B of this embodiment includes an optical pickup 3, a spindle motor 4, a guide rail 5, an access motor 6, a drive element 9, a controller 11B, the memory 12B and the disk discriminator 41. The optical pickup 3 irradiates a radiation beam emitted from a semiconductor laser element onto an optical disk 2. The optical pickup 3 receives light reflected from the optical disk 2 and generates a signal corresponding to intensity of the received light. The spindle motor 4 rotates the optical disk 2. The guide rail 5 is provided approximately parallel to the optical disk 2. The guide rail 5 supports the optical pickup 3 and guides movement of the optical pickup 3 in a radial direction of the optical disk 2. The access motor 6 moves the optical pickup 3 along the guide rail 5 in the radial direction of the optical disk 2. The drive element 9 drives-an actuator for performing tilt adjustment of the optical pickup 3. The controller 11B controls the drive element 9, the optical pickup 3, the access motor 6 and the like. The memory 12B stores processing programs to be executed by the controller 11B, various data and the like. The disk discriminator 41 detects the types of the optical disk 2.

As shown in FIG. 20, sensor sensitivity Ka, zero shift α0 of a detection angle and the like are stored in the memory 12B for each type of the optical disk 2. Moreover, in the case of performing the feed-forward control, detection angles α and voltages V according to addresses on the optical disk 2 are stored as shown in FIG. 21.

The information storage apparatus 1B is configured to be capable of corresponding to a plurality of types of optical disks 2. Specifically, the information storage apparatus 1B is configured to change adjustment data of a tilt sensor 27 depending on the types of the optical disks 2.

In the case of not performing the feed-forward control, the third embodiment is substantially the same as the second embodiment not performing the feed-forward control. The difference between them exists only in the following point. Specifically, the disk discriminator 41 detects the type of the optical disk 2 and the adjustment data is selected based on the result of the detection.

Next, with reference to FIGS. 22 and 23, description will be given of operations of the information storage apparatus 1B in the case of performing the feed-forward control.

The information storage apparatus 1B changes the sensor sensitivity Ka of the tilt sensor 27 to be used based on a physical structure-of the optical disk 2 and a difference in physical properties of the recording surface. In this case, the sensor sensitivity Ka and the zero shift α0 corresponding to each type of the optical disk 2 are measured in assembly/adjustment of the apparatus and stored in the memory 12B.

With reference to FIG. 22, it is assumed that, for example, a certain type of optical disk 2 is mounted (Step SE11). The controller 11B performs normal initialization processing (Step SE12).

When the initialization is finished, the disk discriminator 41 detects the type of optical disk mounted on the apparatus. Based on the detected type of optical disk Dr, the controller 11B selects corresponding sensor sensitivity Kar and zero shift α0r in the memory 12B (Step SE13).

Next, in order to obtain an output of the tilt sensor 27 corresponding to address information, the controller 11B displaces the optical pickup 3 to positions respectively corresponding to a plurality of pre-set addresses Ai *(i=1, 2, . . . p).

Specifically, the controller 11B first sets i=1 (Step SE14) and moves the optical pickup 3 to the address A1s (1≦s≦r) (Step SE15).

Based on an output voltage Vc from the tilt sensor 27, the controller 11B obtains α1s (=F, (A1s)) and V1s in the address A1s (Step SE16). As shown in FIG. 23, the controller 11B stores the obtained α1s (=F (A1s)) and V1s in the memory 12B (Step SE17).

Next, the controller 11B adds 1 to the value i (in this case, i=2) (Step SE18). In Step SE19, the controller 11B determines whether or not the value i exceeds value n. When it is determined that the value i does not exceed value n, the controller 11B repeats the processing of Steps SE15 to SE19.

When it is determined that the value i exceeds value n in Step SE19, the controller 11B performs interpolation processing in Step SE20. Specifically, the controller 11B interpolates the detection angle α and the voltage V with respect to an arbitrary address A on the optical disk 2 based on αis (=F (Ais)) and Vis (i=1, 2, . . . p) which are discretely obtained. The controller 11B obtains a value in the arbitrary address A of the optical pickup 3 and stores the value in the memory 12B (Step SE21).

Thereafter, in Step SE22, in the case of reading information of a predetermined address on the optical disk 2, the controller 11B controls the access motor 6 to displace the optical pickup. 3 to a position corresponding to the predetermined address A. The controller 11B reads the voltage V corresponding to the address A from information storage region 12a of the memory 12B. The controller 11B controls the drive element 9 so as to give the voltage V to the lens actuator 25. The lens actuator 25 changes the optical axis of the radiation beam according to the voltage V. Thus, the tilt angle is compensated. The information storage apparatus 1B accesses the address A on the optical disk 2 by the compensated tilt angle (Step SE22).

According to the third embodiment, it is possible to obtain an effect similar to that of the second embodiment described above.

In addition, the information storage apparatus 1B operates effectively also for a plurality of types of optical disks 2.

The embodiments of the present invention have been described above in detail with reference to the drawings. However, concrete configurations are not limited to those of the embodiments described above and changes of design and the like without departing from the scope of the present invention are included in the present invention.

The information storage apparatuses 1, 1A and 1B are realized not only as an information storage apparatus dedicated to reproduction but also as a write once read many information storage apparatus or a magneto-optical rewritable information storage apparatus. As a matter of course, the information storage apparatuses described above may be configured as an information storage apparatus for reproducing information recorded in the optical disk 2 or for recording information in the optical disk 2. In either case, high-precision tilt control is performed to gain a stable access. Moreover, if the feed-forward control is performed, the feedback control is not required and the apparatus with a simple configuration is realized. Therefore, miniaturization of the apparatus and cost reduction thereof are achieved.

As to the adjustment data stored in the memory 12, Vc1, Vc2, α1 and α2 may be stored instead of the sensor sensitivity Ka of the tilt sensor 7. Moreover, V1, V2, β1 and β2 may be stored in the memory 12 instead of the actuator sensitivity Kc.

Furthermore, as to the information stored in the memory 12, instead of parameters such as the sensitivity and the zero shift described above, formulas for performing compensation, which include those parameters, may be stored.

Moreover, as to the lens actuator, the present invention is not limited to the case of the configuration in which lens actuators for tilt adjustment, for focusing and for tracking are provided independently of each other. Specifically, a configuration may be adopted, in which different drive voltages are applied to a pair of coils for focusing to perform tilt adjustment.

Moreover, in the embodiments, the optical disk 2 is mounted and collection and storage of compensation information (compensation angles and voltages corresponding to the compensation angles) are performed immediately before or immediately after the initialization processing. However, the processing described above may be performed periodically or as the need arises in addition to immediately before or immediately after the initialization processing.

Moreover, in the assembly/adjustment step at the time of manufacturing, the actuator sensitivity Kc, the zero shift β0 of the compensation angle, the sensor sensitivity Ka and the zero shift α0 of the detection angle may be simultaneously obtained.

The adjustment mechanism is not limited to the one realized by use of the actuator but may be realized by use of a liquid crystal panel. Specifically, the liquid crystal panel is disposed in the optical element and the adjustment of the optical axis may be performed by driving the liquid crystal panel.

As described above, according to the configuration of the present invention, control means obtains calibration data for canceling a tilt based on a deviation of a property which is previously measured by an individual test. Thereafter, based on the calibration data, an adjustment mechanism is controlled to compensate at least an angle formed by an optical axis of an optical element and a recording surface of an optical storage medium. Therefore, high-precision tilt control is performed. Moreover, reproduction and/or recording with stable information are realized.

Moreover, if feed-forward control is performed, feedback control is not required and an apparatus with a simple configuration is realized. Thus, miniaturization of the apparatus and cost reduction thereof are achieved.

The present invention has been described in detail. However, it should be appreciated that various changes may be made to the present invention without departing from its spirits.

1. An information storage apparatus for accessing an optical storage medium, said storage apparatus comprising:
an optical element emitting and/or receiving a radiation beam along an optical axis;
a detector producing a first signal representing a tilt angle of said storage medium with respect to said detector;
an adjustment mechanism compensating a tilt angle between said optical axis of said radiation beam and a direction normal to said optical storage medium in response to a second signal;
a memory storing calibration data obtained based on relationship information about a relationship between said first and second signals and tilt-angle information about said tilt angle detected by said detector;
a controller generating said second signal referring to said calibration data such that said tilt angle is substantially canceled,
wherein said relationship information reflects a deviation of a property of at least one of said detector and said adjustment mechanism measured by an individual test.

2. The information storage apparatus according to claim 1, wherein
said detector detects tilt angles of said optical storage medium at a plurality of points of measurement on said optical storage medium,
said tilt-angle information reflects said tilt angles detected by said detector.

3. The information storage apparatus according to claim 2, wherein positions of said points of measurement are determined by distance from an inner radius.

4. The information storage apparatus according to claim 3, wherein
said optical storage medium includes a spiral or concentric track,
addresses are assigned to portions of said track, and
said points of measurement correspond to portions of said tracks having predetermined addresses.

5. The information storage apparatus according to claim 1, wherein said relationship information includes a set of adjustment data corresponding to different types of optical storage medium.

6. The information storage apparatus according to claim 1, wherein said adjustment mechanism changes an orientation of said optical axis of said radiation beam.

7. The information storage apparatus according to claim 1, wherein said adjustment mechanism comprises a liquid crystal device.

8. The information storage apparatus according to claim 1, wherein said adjustment mechanism compensates said tilt angle under feed-forward control.

9. A method for accessing to an optical storage medium, said method comprising:
storing relationship information which reflects a deviation of a property of at least one of a detector and a adjustment mechanism measured by an individual test to a memory;
storing calibration data obtained based on relationship information about a relationship between first and second signals and tilt-angle information about said tilt angle detected by said detector;
producing said first signal representing a tilt angle of said storage medium with respect to said detector;
generating said second signal referring to said calibration data based on said first signal such that said tilt angle is substantially canceled, and
compensating a tilt angle between an optical axis of a radiation beam and a direction normal to said optical storage medium in response to a second signal.
